(19) United States
(12) Patent Application Publication
(10) Pub. No.: US 2013/0328520 A1
(43) Pub. Date: Dec. 12, 2013

(54) FLASH CHARGING PROTECTION CIRCUIT AND CONTROL METHOD THEREOF

(71) Applicants: Pei-Shin Chen, Hsinchu County (TW); Yueh-Chang Chen, Hsinchu County (TW)

(72) Inventors: Pei-Shin Chen, Hsinchu County (TW); Yueh-Chang Chen, Hsinchu County (TW)

(73) Assignee: ALTEK CORPORATION, Hsinchu City (TW)

(21) Appl. No.: 13/565,804

(22) Filed: Aug. 3, 2012

(30) Foreign Application Priority Data
Jun. 8, 2012 (TW) 101120701

(51) Int. Cl. H02J 7/00

(52) U.S. Cl. 320/107

(57) ABSTRACT

A flash charging protection circuit and a control method thereof adapted to a charging circuit coupled to a power supply are provided. An analog-to-digital converter receives a feedback voltage output from the charging circuit and an input voltage output from the power supply. A power voltage detection module detects whether the input voltage is abnormal or not. A charging state detection module detects whether a rising curve of the feedback voltage is abnormal or not. If a controller receives a power abnormal signal or a charging state abnormal signal, the controller disables a pulse width modulation signal generator to produce a pulse width modulation signal.

### CROSS-REFERENCE TO RELATED APPLICATION

This application claims the priority benefit of Taiwan application serial no. 101120701, filed on Jun. 8, 2012. The entirety of the above-mentioned patent application is hereby incorporated by reference herein and made a part of this specification.

### BACKGROUND

1. Technical Field

The invention relates to a flash charging protection circuit. Particularly, the invention relates to a digital flash charging protection circuit.

2. Related Art

In a digital camera or a digital video camera, a flash module is an indispensable component. In a circuit of the flash module, an energy storage element such as a capacitor is generally used to store energy for triggering a flash. Since a voltage of the capacitor may reach 300 volts, to be used as a consumable electronic product, the circuit has to comply with safety specifications.

A conventional charging protection circuit is mainly implemented by a flash charging integrated chip (IC). When a feedback loop is abnormal, the flash charging IC determines the abnormity according to a feedback voltage, and opportunely stops charging to prevent a charging voltage from being greater than a limit of the capacitor. However, the conventional charging protection circuit can only detect whether a feedback resistor is short-circuited or open-circuited before the charging operation or during the charging operation. When the feedback resistor is short-circuited or open-circuited, the charging protection circuit opportunely stops charging, though such protection mechanism is incomplete. Moreover, the above protection mechanism only protects a charging process, which cannot detect whether capacitor discharging is abnormal. Therefore, if a flash trigger loop is abnormal, i.e. the capacitor discharging is abnormal to cause flashing failure, a captured image may have a problem of underexposure. Moreover, since the charging protection circuit cannot detect whether the flash trigger loop is abnormal, the digital camera or the digital video camera may mistake that the flashing is successful and perform a next charging operation, which is easy to cause a damage of the digital camera or the digital video camera. Moreover, the flash charging IC occupies a certain area of a circuit board, which is of no avail for reducing production cost.

### SUMMARY

Accordingly, the invention is directed to a flash charging protection circuit and a control method thereof, in which charging protection is implemented according to variation of a feedback voltage of a charging circuit.

The invention provides a flash charging protection circuit, which is adapted to a charging circuit coupled to a power supply. The charging circuit includes a power switch and a transformer, where the power switch is coupled to a first side winding of the transformer. The flash charging protection circuit includes an analog-to-digital converter (ADC), a power voltage detection module, a charging state detection module, a controller and a pulse width modulation (PWM) signal generator.

The ADC is coupled to a second side winding of the transformer, and receives a feedback voltage output from the charging circuit and an input voltage output from the power supply, and converts the feedback voltage and the input voltage of an analog format into the feedback voltage and the input voltage of a digital format. The power voltage detection module is coupled to the ADC, and detects whether the input voltage is abnormal, and outputs a power abnormal signal when the input voltage is abnormal. The charging state detection module is coupled to the ADC, and detects whether a rising curve of the feedback voltage is abnormal, and outputs a charging state abnormal signal when the rising curve is abnormal. The controller is coupled to the power voltage detection module and the charging state detection module. The PWM signal generator is coupled to the controller and the power switch, and produces a PWM signal to the power switch, where when the controller receives the power abnormal signal or the charging state abnormal signal, the controller disables the PWM signal generator to produce the PWM signal.

In an embodiment of the invention, when the charging state detection module produces a check feedback voltage command, the controller enables the PWM signal generator to produce the PWM signal within a predetermined time, and disables the PWM signal generator to produce the PWM signal after the predetermined time, so as to obtain the feedback voltage.

In an embodiment of the invention, the second side winding of the transformer is coupled to an energy storage element through a diode, and after the energy storage element performs a discharging operation, the charging state detection module generates the check feedback voltage command to obtain a first feedback voltage of the energy storage element after performing the discharging operation, and when the first feedback voltage is greater than the discharging check voltage, the charging state detection module outputs a discharging state abnormal signal to the controller.

In an embodiment of the invention, the charging state detection module includes a first charging state detection unit, which respectively obtains an initial feedback voltage and a second feedback voltage according to an initial time point and a first predetermined time point, and subtracts the initial feedback voltage and the second feedback voltage to obtain a part of the rising curve of the feedback voltage, and outputs the charging state abnormal signal when the part of the rising curve is not conformed with a normal charging curve.

In an embodiment of the invention, the charging state detection module includes a second charging state detection unit, which periodically detects another part of the rising curve of the feedback voltage according to a protection check time after the first predetermined time point, and outputs the charging state abnormal signal when the other part of the rising curve is not conformed with the normal charging curve.

In an embodiment of the invention, the flash charging protection circuit further includes a timeout counter coupled to the charging state detection module, which starts counting from the initial time point, and when a counted accumulative time of the timeout counter is greater than a predetermined charging time, and the feedback voltage does not reach a target voltage, the timeout counter outputs a charging time abnormal signal to the controller, and the controller disables the PWM signal generator to produce the PWM signal.

In an embodiment of the invention, the power voltage detection module receives a first predetermined voltage and a second predetermined voltage, and the power voltage detection module outputs the power abnormal signal when the detected input voltage of the power supply is not within a range of the first predetermined voltage and the second predetermined voltage.

In an embodiment of the invention, the flash charging protection circuit further includes a system clock detection module coupled to the controller, which detects a system clock signal received by the flash charging protection circuit, and when a frequency of the system clock signal is lower than or greater than a predetermined working range, the system clock detection module generates a clock abnormal signal to the controller, so as to disable the PWM signal generator to produce the PWM signal.

The invention provides a control method of a flash charging protection circuit, where the flash charging protection circuit is coupled to a charging circuit having a power switch and a transformer, the charging circuit is coupled to a power supply, and the control method of the flash charging protection circuit is to control a switching operation of the power switch of the charging circuit, which includes following steps. A feedback voltage output from the charging circuit and an input voltage output from the power supply are received, and the feedback voltage and the input voltage of an analog format are converted into the feedback voltage and the input voltage of a digital format. Moreover, it is detected whether the input voltage is abnormal, and a power abnormal signal is output when the input voltage is abnormal. Moreover, it is detected whether a rising curve of the feedback voltage is abnormal, and a charging state abnormal signal is output when the rising curve is abnormal. It is determined whether or not to produce a PWM signal to the power switch according to the power abnormal signal or the charging state abnormal signal.

In an embodiment of the invention, the step of detecting whether the rising curve of the feedback voltage is abnormal, and outputting the charging state abnormal signal when the rising curve is abnormal includes enabling a PWM signal generator to produce the PWM signal within a predetermined time according to a check feedback voltage command, and disabling the PWM signal generator to produce the PWM signal after the predetermined time, so as to obtain the feedback voltage of the charging circuit.

In an embodiment of the invention, a second side winding of the transformer is coupled to an energy storage element through a diode, and the control method further includes after the energy storage element performs a discharging operation, obtaining a first feedback voltage of the energy storage element after performing the discharging operation according to the check feedback voltage command, and outputting a discharging state abnormal signal when the first feedback voltage is greater than a discharging check voltage.

In an embodiment of the invention, the control method of the flash charging protection circuit further includes respectively obtaining an initial feedback voltage and a second feedback voltage according to an initial time point and a first predetermined time point, and subtracting the initial feedback voltage and the second feedback voltage to obtain a part of the rising curve of the feedback voltage, and outputting the charging state abnormal signal when the part of the rising curve is not conformed with a normal charging curve.

In an embodiment of the invention, the control method of the flash charging protection circuit further includes periodically detecting another part of the rising curve of the feedback voltage according to a protection check time after the first predetermined time point, and outputting the charging state abnormal signal when the other part of the rising curve is not conformed with the normal charging curve.

In an embodiment of the invention, the control method of the flash charging protection circuit further includes starting counting from the initial time point, and outputting a charging time abnormal signal to disable the PWM signal generator to produce the PWM signal when a counted accumulative time is greater than a predetermined charging time, and the feedback voltage does not reach a target voltage.

In an embodiment of the invention, the step of detecting whether the input voltage is abnormal, and outputting the power abnormal signal when the input voltage is abnormal includes receiving a first predetermined voltage and a second predetermined voltage, and outputting the power abnormal signal when the detected input voltage of the power supply is not within a range of the first predetermined voltage and the second predetermined voltage.

In an embodiment of the invention, the control method of the flash charging protection circuit further includes detecting a system clock signal received by the flash charging protection circuit, and outputting a clock abnormal signal to disable the PWM signal generator to produce the PWM signal when a frequency of the system clock signal is lower than or greater than a predetermined working range.

According to the above descriptions, the flash charging protection circuit and the control method thereof are constructed base on a digital flash charging protection circuit, and charging protection is implemented according to variation of the feedback voltage of the charging circuit, so as to improve an effect of the protection mechanism.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a flash charging protection circuit according to an embodiment of the invention.

FIG. 2 is a signal waveform diagram of a flash charging protection circuit according to an embodiment of the invention.

FIG. 3 is a flowchart illustrating a control method of a flash charging protection circuit according to an embodiment of the invention.

FIG. 4 is a diagram of a flash charging protection circuit according to another embodiment of the invention.

FIG. 5 is a flowchart illustrating a control method of a flash charging protection circuit according to another embodiment of the invention.

### DETAILED DESCRIPTION OF DISCLOSED EMBODIMENTS

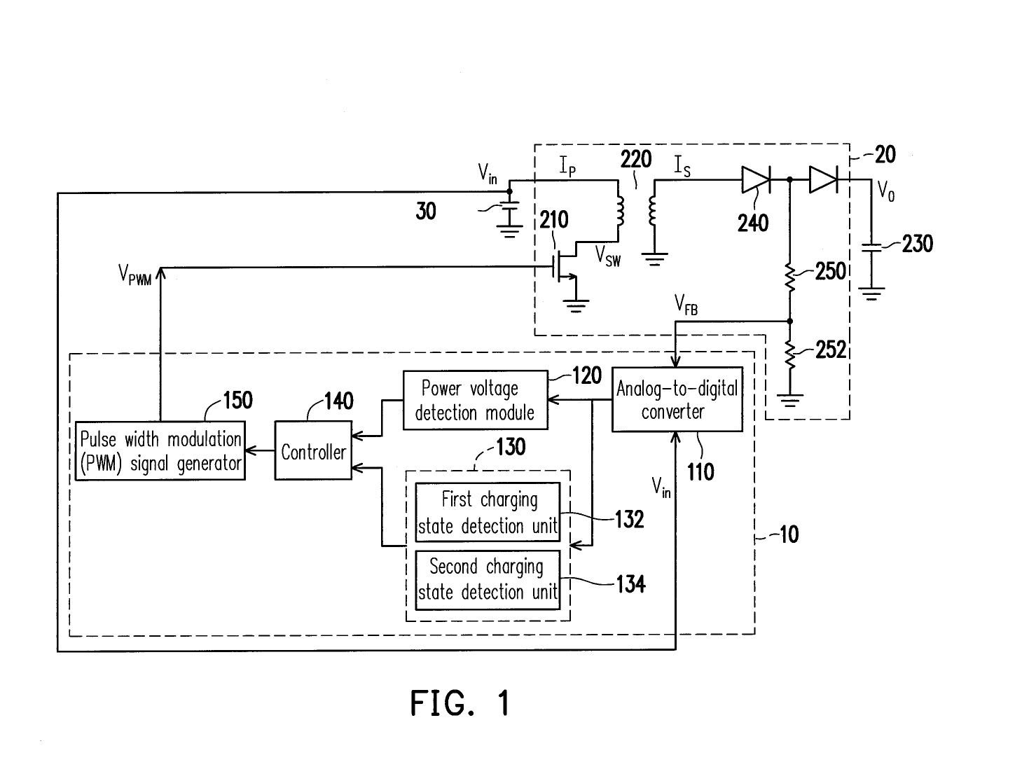

FIG. 1 is a diagram of a flash charging protection circuit according to an embodiment of the invention. Referring to FIG. 1, the flash charging protection circuit 10 is adapted to a charging circuit 20, and the charging circuit 20 includes a power switch 210 and a transformer 220, where the power switch 210 is coupled to a first side winding of the transformer 220. A power supply 30 is coupled to the first side winding of the transformer 220, and provides an input voltage Vᵢₙ. The transformer 220 transforms the input voltage Vᵢₙ to output an output voltage Vₒ through a second side winding thereof, and the output voltage Vₒ can be used to charge an energy storage element. In the present embodiment, the power switch 210 is, for example, a power metal oxide semiconductor field effect transistor (MOSFET), and the energy storage element is, for example, a capacitor 230. Moreover, to prevent electricity leakage of the capacitor 230 after the capacitor 230 is fully charged, at least one diode 240 (two diodes are illustrated in FIG. 1, though the invention is not limited thereto) can be coupled between the second side winding of the transformer 220 and the capacitor 230 to prevent the electricity leakage.

The flash charging protection circuit 10 is coupled between the first side winding and the second side winding of the transformer 220, and receives the input voltage Vᵢₙ of the first side winding and a feedback voltage V_{FB} of the second side winding. In this way, the flash charging protection circuit 10 can determine whether the charging operation is abnormal according to the input voltage Vᵢₙ and the feedback voltage V_{FB}. In detail, an upper arm resistor 250 and a lower arm resistor 252 are coupled to the diode 240, and the flash charging protection circuit 10 is coupled between the upper arm resistor 250 and the lower arm resistor 252 to obtain a divided voltage of the capacitor 230 to serve as the feedback voltage V_{FB}. In this way, the flash charging protection circuit 10 can determine whether the voltage of the capacitor 230 is normal by reading the feedback voltage V_{FB}. Moreover, the capacitor 230 can be connected to a flash (not shown), so that the flash can be activated through the energy stored in the capacitor 230.

The flash charging protection circuit 10 can be used to produce a pulse width modulation (PWM) signal V_{PWM} to the power switch 210, so that the input voltage Vᵢₙ is selectively input to the first side winding of the transformer 220. A detailed operation of the flash charging protection circuit 10 is described below:

The flash charging protection circuit 10 includes an analog-to-digital converter (ADC) 110, a power voltage detection module 120, a charging state detection module 130, a controller 140 and a PWM signal generator 150. The ADC 110 is coupled to the first side winding and the second side winding of the transformer 220, and receives the feedback voltage V_{FB} output from the charging circuit 20 and the input voltage Vᵢₙ of the power supply 30, and converts the feedback voltage V_{FB} and the input voltage Vᵢₙ of an analog format into the feedback voltage V_{FB} and the input voltage Vᵢₙ of a digital format.

The power voltage detection module 120 is coupled to the ADC 110, and detects whether the input voltage Vᵢₙ is abnormal. In detail, the power voltage detection module 120 can detect whether the input voltage Vᵢₙ of the power supply 30 is within a range between a first predetermined voltage and a second predetermined voltage. If the input voltage Vᵢₙ is not within the range between the first predetermined voltage and the second predetermined voltage, the power voltage detection module 120 outputs a power abnormal signal to the controller 140. Now, the controller 140 disables the PWM signal generator 150 to produce the PWM signal V_{PWM}. For example, when the power supply 30 is a battery, and it is assumed that a working voltage of a normal battery is between 3.3 volts and 1.8 volts, the first predetermined voltage and the second predetermined voltage can be respectively set to 3.3 volts and 1.8 volts. Before the charging circuit 20 starts the charging operation, if the power voltage detection module 120 detects the input voltage Vᵢₙ of the power supply 30 to be outside such range, the charging circuit 20 stops the charging operation.

The charging state detection module 130 is coupled to the ADC 110 and the controller 140, and detects whether a rising curve of the feedback voltage V_{FB} is abnormal. When the charging state detection module 130 determines that the rising curve is abnormal, it outputs a charging state abnormal signal to the controller 140. In an embodiment, the charging state detection module 130 may include a first charging state detection module 132 and a second charging state detection module 134. The first charging state detection module 132 obtains the feedback voltage V_{FB} at an initial time point of charging the capacitor 230 to serve as an initial feedback voltage, and then obtains the feedback voltage V_{FB} at a first predetermined time point of the charging operation to serve as a second feedback voltage. If a voltage difference between the initial feedback voltage and the second feedback voltage is smaller than a predetermined value, it represents that a rising trend of a charging voltage within the above time section is too flat. Namely, a part of the rising curve of the feedback voltage within such time section is not conformed with a normal charging curve. Now, the charging state detection module 130 determines that a certain component on a feedback path or a charging path has a problem, and outputs the charging state abnormal signal to the controller 140 to stop charging.

For example, a time different between the initial time point and the first predetermined time point can be regarded as a charging initial check time. The charging initial check time can be set by software, which can be 50 milliseconds. It is assumed that in a complete charging process, the feedback voltage V_{FB} has to be increased by 1024 levels, and within the charging initial check time, the feedback voltage V_{FB} has to be increased by at least 5 levels in order to conform with the rising curve. If the first charging state detection unit 132 determines that the voltage difference is less than 5 levels within the charging initial check time, it represent that charging abnormity is probably occurred.

The second charging state detection unit 134 of the charging state detection module 130 can periodically detect another part of the rising curve of the feedback voltage according to a protection check time after the first predetermined time point, and outputs the charging state abnormal signal to the controller 140 to stop charging when the other part of the rising curve is not conformed with the normal charging curve.

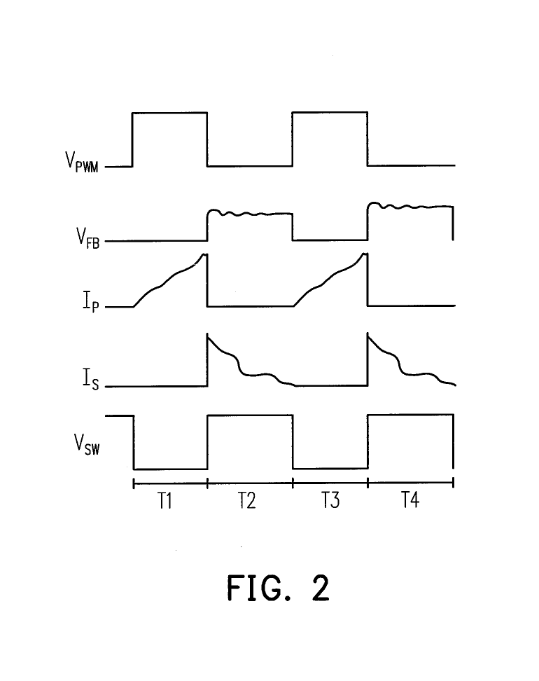

FIG. 2 is a signal waveform diagram of the flash charging protection circuit according to an embodiment of the invention. Referring to FIG. 1 and FIG. 2, the charging state detection module 130 can generate a check feedback voltage command at any time point according to a software setting. After the controller 140 receives the check feedback voltage command, the controller 140 enables the PWM signal generator 150 to produce the PWM signal V_{PWM} within a predetermined time. For example, within a first timing T1, the controller 140 sets the PWM signal V_{PWM} of the PWM signal generator 150 to a high level, so as to turn on the power switch 210. Now, a node voltage V_{SW} has a low level, so that the transformer 220 is charged through the power supply 30, and a first side current I_{P} is gradually increased.

After the predetermined time, the controller 140 disables the PWM signal generator 150. Namely, in a second timing T2, the controller 140 sets the PWM signal V_{PWM} of the PWM signal generator 150 to a low level, so as to turn off the power switch 210. Now, the node voltage V_{SW} has a high level. When the PWM signal V_{PWM} is switched from the high level to the low level, a second side current I_{S} has a maximum value, and the transformer 220 starts to charge the capacitor 230 through a discharging loop (the diode 240 is now in a turn-on state). Now, the charging state detection module 130 obtains the feedback voltage V_{FB}. As the charging time increases, the second side current I_{S} is gradually decreased, and when the second side current I_{S} is decreased to zero, the feedback voltage V_{FB} disappears.

It should be noticed that since the feedback voltage V_{FB} is a divided voltage of a voltage of the capacitor 230, the charging state detection module 130 can obtain the feedback voltage V_{FB} at any time point to derive the voltage of the capacitor 230. When the feedback voltage V_{FB} is abnormal, it represents that the voltage of the capacitor 230 is abnormal, and an error voltage threshold can be set for charging protection, so as to opportunely disable the charging function. For example, it is assumed that the feedback voltage V_{FB} is about 2.8 volts in case that the capacitor 230 is fully charged, and the error voltage threshold is set to 3 volts. When the feedback voltage V_{FB} obtained by the charging state detection module 130 is greater than 3 volts, the controller 140 immediately disables the PWM signal generator 150 to stop charging.

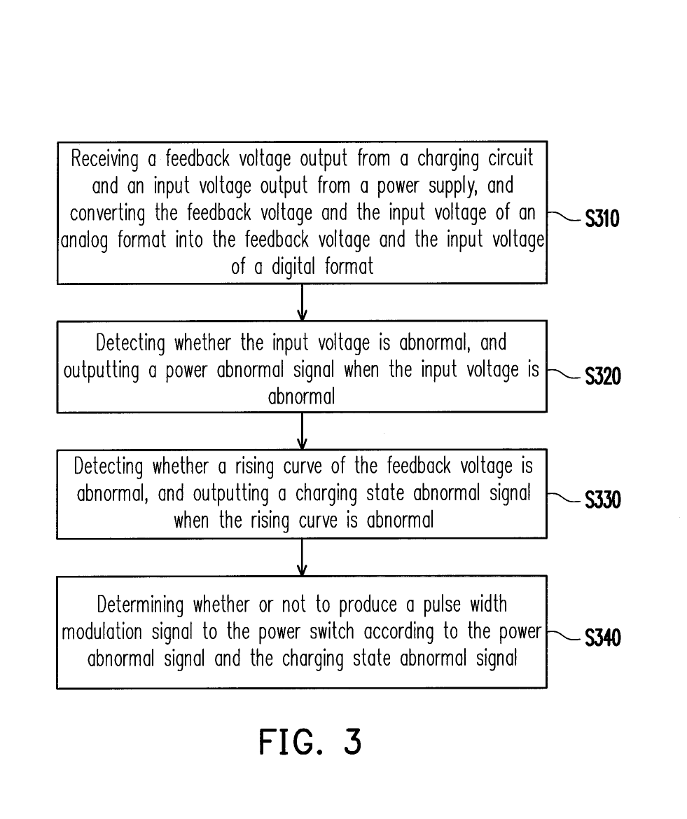

A control method of the flash charging protection circuit can be deduced below according to the above descriptions. FIG. 3 is a flowchart illustrating a control method of a flash charging protection circuit according to an embodiment of the invention. Various steps of the present embodiment are described below with reference of the components of FIG. 1. First, in step S310, the ADC 110 receives a feedback voltage V_{FB} output from the charging circuit 20 and an input voltage Vᵢₙ of the power supply 30, and converts the feedback voltage V_{FB} and the input voltage Vᵢₙ of an analog format into the feedback voltage V_{FB} and the input voltage Vᵢₙ of a digital format. In step S320, the power voltage detection module 120 detects whether the input voltage Vᵢₙ is abnormal, and outputs a power abnormal signal if the input voltage Vᵢₙ is abnormal. In step S330, the charging state detection module 130 detects whether a rising curve of the feedback voltage V_{FB} is abnormal, and outputs a charging state abnormal signal when the rising curve is abnormal. Finally, in step S340, the controller 140 determines to enable or disable the PWM signal generator 150 to produce the PWM signal V_{PWM} to the power switch 210 according to the power abnormal signal and the charging state abnormal signal.

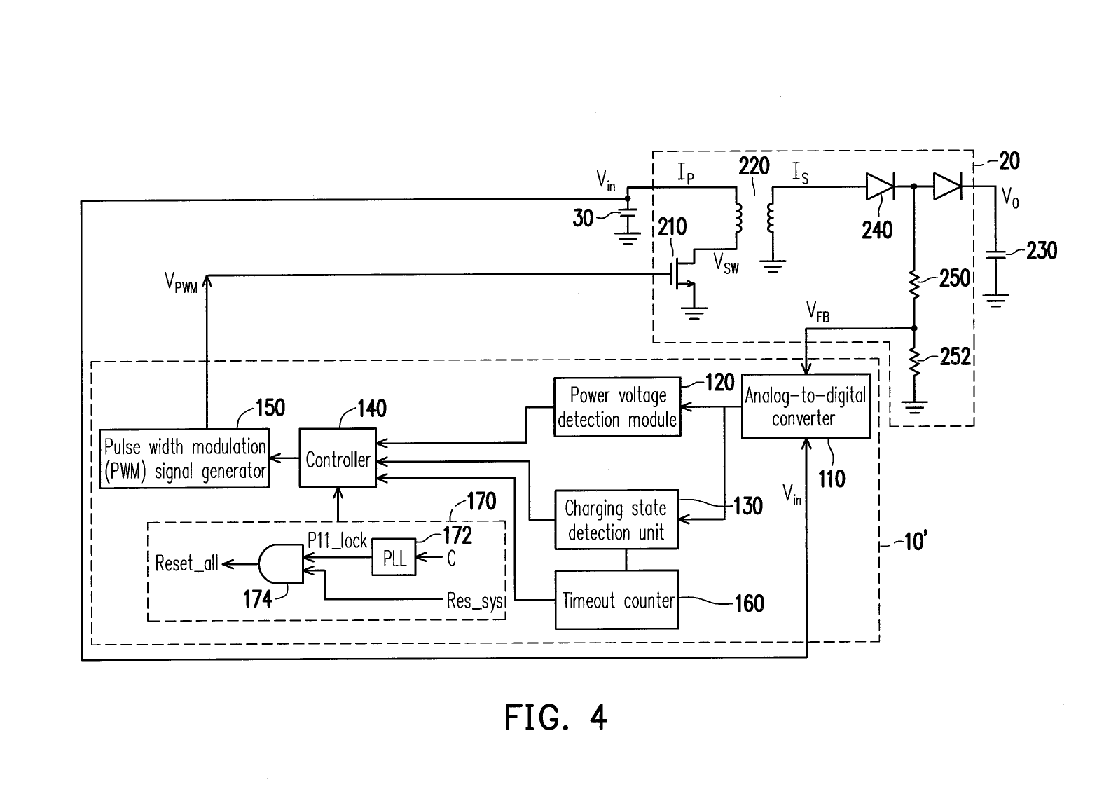

FIG. 4 is a diagram of a flash charging protection circuit according to another embodiment of the invention. Referring to FIG. 4, besides including the ADC 110, the power voltage detection module 120, the charging state detection module 130, the controller 140 and the PWM signal generator 150, the flash charging protection circuit 10′ further includes a timeout counter 160 coupled to the charging state detection module 130 and a system clock detection module 170 coupled to the controller 140.

The timeout counter 160 starts counting from the initial time point, and when a counted accumulative time of the timeout counter 160 is greater than a predetermined charging time, and the feedback voltage V_{FB} does not reach a target voltage, the timeout counter 160 outputs a charging time abnormal signal to the controller 140, and the controller 140 disables the PWM signal generator 150 to produce the PWM signal V_{PWM}. The predetermined charging time can be preset by software, and the timeout counter 160 is another protection defence line in case that the charging time exceeds an expected time, and the aforementioned charging protection mechanism is not activated.

The system clock detection module 170 detects a system clock signal C received by the flash charging protection circuit 10′. In the present embodiment, the timeout counter 160 implemented by software or hardware operates according to the system clock signal C. Therefore, if the system clock signal C is abnormal, the PWM signal V_{PWM} is probably maintained to the high level, which may damage or burn the power switch 210 and the transformer 220 on the charging loop. Therefore, when a frequency of the system clock signal C is lower than or greater than a predetermined working range, the system clock detection module 170 generates a clock abnormal signal to the controller 140, so as to disable the PWM signal generator 150 to produce the PWM signal V_{PWM}.

As shown in FIG. 4, the system clock detection module 170 includes a phase-locked loop (PLL) unit 172 and an AND gate 174. A PLL signal Pll_lock generated by the PLL unit 172 and a system reset signal Res_sys are input to the AND gate 174 for processing. The system reset signal Res_sys is set to the high level in case that the power of the flash charging protection circuit is turned on, and when the PLL unit 172 detects that the system clock signal C is abnormal, it sets the PLL signal Pll_lock to the low level, and now the AND gate 174 outputs a low level clock abnormal signal Reset_all to the controller 140. When the controller 140 receives the low level clock abnormal signal Reset_all, it disables the PWM signal generator 150 to produce the PWM signal V_{PWM}. In other words, the PWM signal V_{PWM} has the low level.

Moreover, when the capacitor 230 performs a discharging operation (for example, to charge a flash), the charging state detection module 130 generates a check feedback voltage command to the controller 140 to obtain the feedback voltage V_{FB} of the capacitor 230 after flashing. When the feedback voltage V_{FB} is greater than a discharging check voltage (for example, a fully charged voltage), it means the flashing is failed. Namely, the voltage of the capacitor 230 is not released. Now, the charging state detection module 130 may output a discharging state abnormal signal to the controller 140 to disable the PWM signal generator 150 to produce the PWM signal V_{PWM}. The other modules of the present embodiment are the same or similar to that in the embodiment of FIG. 1, and details thereof are not repeated. However, it should be noticed that in the various protection mechanisms of the aforementioned flash charging protection circuit, besides that the system clock protection mechanism is activated by default, the other protection mechanisms such as the power voltage protection mechanism or the charging state protection mechanism, etc. can all be activated or deactivated through software selection, by which usage flexibility of the flash charging protection circuit is increased.

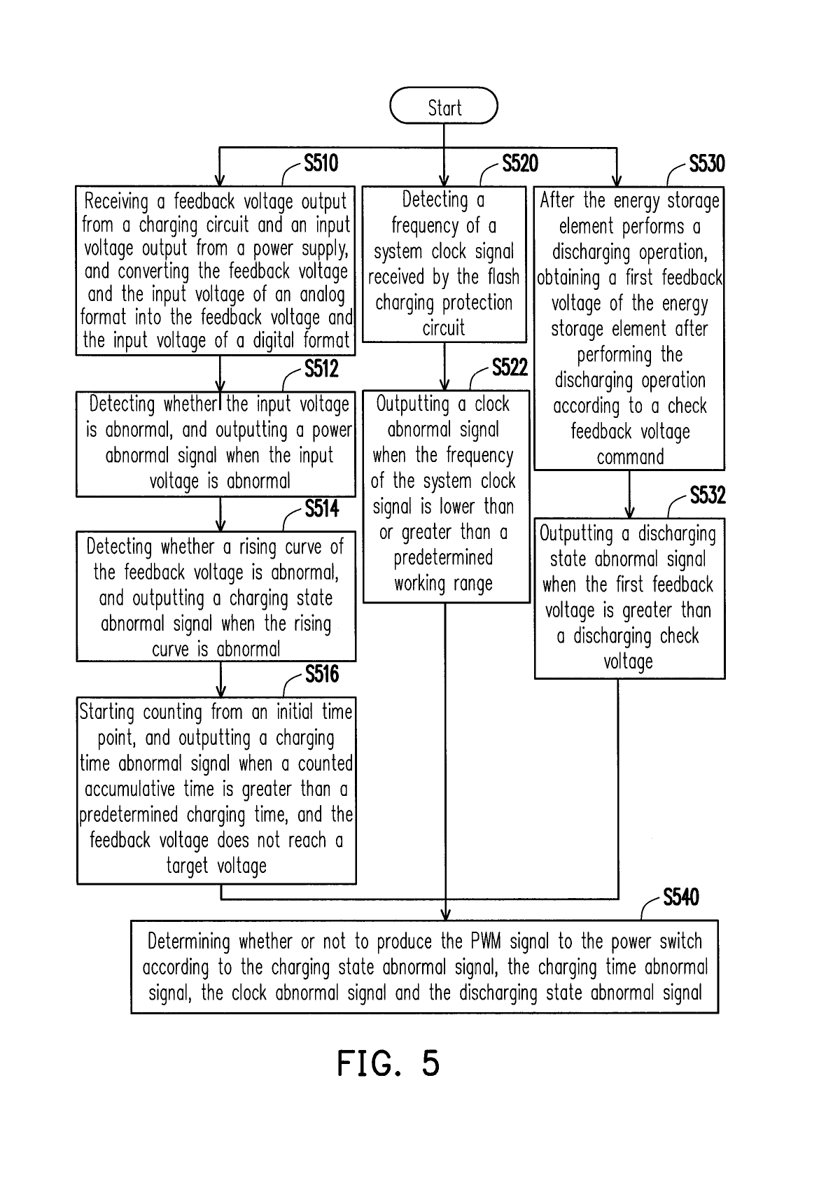

Similarly, a control method of the flash charging protection circuit can be deduced below according to the above descriptions. FIG. 5 is a flowchart illustrating a control method of a flash charging protection circuit according to another embodiment of the invention. The control method of FIG. 5 is adapted to the flash charging protection circuit of FIG. 4, and is described below with reference of FIG. 4 and FIG. 5.

First, steps S510-S514 are similar to the steps S310-S330 of FIG. 3, i.e. the power voltage detection module 120 detects whether the input voltage Vᵢₙ is abnormal, and outputs the power abnormal signal when the input voltage Vᵢₙ is abnormal. The charging state detection module 130 detects whether the rising curve of the feedback voltage V_{FB} is abnormal, and outputs the charging state abnormal signal when the rising curve is abnormal. Then, in step S516, the timeout counter 160 starts counting from an initial time point, where the initial time point represents a time point when the charging operation starts, and when a counted accumulative time of the timeout counter 160 is greater than a predetermined charging time, and the feedback voltage V_{FB} does not reach a target voltage, the timeout counter 160 outputs a charging time abnormal signal.

In the present embodiment, while the steps S510-S516 are executed, steps S520-S522 can also be executed simultaneously, and in the step S520, the system clock detection module 170 detects a system clock signal C received by the flash charging protection circuit 10′, and when a frequency of the system clock signal C is lower than or greater than a predetermined working range, the system clock detection module 170 outputs a clock abnormal signal. Moreover, in step S530, when the capacitor 230 performs a discharging operation (for example, to charge a flash), the charging state detection module 130 generates a check feedback voltage command to obtain the feedback voltage V_{FB} of the capacitor 230 after flashing. Then, in step S532, when the feedback voltage V_{FB} is greater than a discharging check voltage (for example, a fully charged voltage), it means the flashing is failed, i.e. the voltage of the capacitor 230 is not released, and now the charging state detection module 130 outputs a discharging state abnormal signal.

Finally, in step S540, when the controller 140 receives the power abnormal signal, the charging state abnormal signal, the charging time abnormal signal, the clock abnormal signal or the discharging state abnormal signal, the controller 140 disables the PWM signal generator 150 to produce the PWM signal V_{PWM}, and now the PWM signal V_{PWM} has a low level, which may protect the charging circuit 20.

In summary, according to the flash charging protection circuit and the control method thereof of the invention, the voltage of the energy storage element can be obtained at any time point to check whether the charging circuit is normal, and under different charging states, the charging protection is implemented by using the variation of the feedback voltage of the charging circuit. Moreover, after the energy storage element performs the discharging operation, a flashing status is checked to determine whether or not to perform a next charging/discharging operation. The flash charging protection circuit of the invention is a digital protection circuit, which can be simply applied in various manufacturing processes.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A flash charging protection circuit, adapted to a charging circuit coupled to a power supply, wherein the charging circuit comprises a power switch and a transformer, and the power switch is coupled to a first side winding of the transformer, the flash charging protection circuit comprising:
an analog-to-digital converter, coupled to a second side winding of the transformer, receiving a feedback voltage output from the charging circuit and an input voltage output from the power supply, and converting the feedback voltage and the input voltage of an analog format into the feedback voltage and the input voltage of a digital format;
a power voltage detection module, coupled to the analog-to-digital converter, detecting whether the input voltage is abnormal, and outputting a power abnormal signal when the input voltage is abnormal;
a charging state detection module, coupled to the analog-to-digital converter, detecting whether a rising curve of the feedback voltage is abnormal, and outputting a charging state abnormal signal when the rising curve is abnormal;
a controller, coupled to the power voltage detection module and the charging state detection module; and
a pulse width modulation signal generator, coupled to the controller and the power switch, and producing a pulse width modulation signal to the power switch, wherein when the controller receives the power abnormal signal or the charging state abnormal signal, the controller disables the pulse width modulation signal generator to produce the pulse width modulation signal.

2. The flash charging protection circuit as claimed in claim 1, wherein when the charging state detection module produces a check feedback voltage command, the controller enables the pulse width modulation signal generator to produce the pulse width modulation signal within a predetermined time, and disables the pulse width modulation signal generator to produce the pulse width modulation signal after the predetermined time, so as to obtain the feedback voltage.

3. The flash charging protection circuit as claimed in claim 2, wherein the second side winding of the transformer is coupled to an energy storage element through at least one diode, wherein
after the energy storage element performs a discharging operation, the charging state detection module generates the check feedback voltage command to obtain a first feedback voltage of the energy storage element after performing the discharging operation, and when the first feedback voltage is greater than a discharging check voltage, the charging state detection module outputs a discharging state abnormal signal to the controller.

4. The flash charging protection circuit as claimed in claim 1, wherein the charging state detection module comprises:
a first charging state detection unit, respectively obtaining an initial feedback voltage and a second feedback voltage according to an initial time point and a first predetermined time point, subtracting the initial feedback voltage and the second feedback voltage to obtain a part of the rising curve of the feedback voltage, and outputting the charging state abnormal signal when the part of the rising curve is not conformed with a normal charging curve.

5. The flash charging protection circuit as claimed in claim 4, wherein the charging state detection module comprises:
a second charging state detection unit, periodically detecting another part of the rising curve of the feedback voltage according to a protection check time after the first predetermined time point, and outputting the charging state abnormal signal when the other part of the rising curve is not conformed with the normal charging curve.

6. The flash charging protection circuit as claimed in claim 4, further comprising:
a timeout counter, coupled to the charging state detection module, starting counting from the initial time point, wherein when a counted accumulative time of the timeout counter is greater than a predetermined charging time, and the feedback voltage does not reach a target voltage, the timeout counter outputs a charging time abnormal signal to the controller, and the controller disables the pulse width modulation signal generator to produce the pulse width modulation signal.

7. The flash charging protection circuit as claimed in claim 1, wherein the power voltage detection module receives a first predetermined voltage and a second predetermined voltage, and outputs the power abnormal signal when the detected input voltage of the power supply is not within a range of the first predetermined voltage and the second predetermined voltage.

8. The flash charging protection circuit as claimed in claim 1, further comprising:
a system clock detection module, coupled to the controller, and detecting a system clock signal received by the flash charging protection circuit, wherein when a frequency of the system clock signal is lower than or greater than a predetermined working range, the system clock detection module generates a clock abnormal signal to the controller, so as to disable the pulse width modulation signal generator to produce the pulse width modulation signal.

9. A control method of a flash charging protection circuit, wherein the flash charging protection circuit is coupled to a charging circuit having a power switch and a transformer, the charging circuit is coupled to a power supply, and the control method of the flash charging protection circuit is to control a switching operation of the power switch of the charging circuit, and the control method of the flash charging protection circuit comprising:
receiving a feedback voltage output from the charging circuit and an input voltage output from the power supply, and converting the feedback voltage and the input voltage of an analog format into the feedback voltage and the input voltage of a digital format;
detecting whether the input voltage is abnormal, and outputting a power abnormal signal when the input voltage is abnormal;
detecting whether a rising curve of the feedback voltage is abnormal, and outputting a charging state abnormal signal when the rising curve is abnormal; and
determining whether or not to produce a pulse width modulation signal to the power switch according to the power abnormal signal or the charging state abnormal signal.

10. The control method of the flash charging protection circuit as claimed in claim 9, wherein the step of detecting whether the rising curve of the feedback voltage is abnormal, and outputting the charging state abnormal signal when the rising curve is abnormal comprises:
enabling a pulse width modulation signal generator to produce the pulse width modulation signal within a predetermined time according to a check feedback voltage command, and disabling the pulse width modulation signal generator to produce the pulse width modulation signal after the predetermined time, so as to obtain the feedback voltage of the charging circuit.

11. The control method of the flash charging protection circuit as claimed in claim 10, wherein a second side winding of the transformer is coupled to an energy storage element through at least one diode, and the control method further comprises:
after the energy storage element performs a discharging operation, obtaining a first feedback voltage of the energy storage element after performing the discharging operation according to the check feedback voltage command, and outputting a discharging state abnormal signal when the first feedback voltage is greater than a discharging check voltage.

12. The control method of the flash charging protection circuit as claimed in claim 9, further comprising:
respectively obtaining an initial feedback voltage and a second feedback voltage according to an initial time point and a first predetermined time point, and subtracting the initial feedback voltage and the second feedback voltage to obtain a part of the rising curve of the feedback voltage, and outputting the charging state abnormal signal when the part of the rising curve is not conformed with a normal charging curve.

13. The control method of the flash charging protection circuit as claimed in claim 12, further comprising:
periodically detecting another part of the rising curve of the feedback voltage according to a protection check time after the first predetermined time point, and outputting the charging state abnormal signal when the other part of the rising curve is not conformed with the normal charging curve.

14. The control method of the flash charging protection circuit as claimed in claim 12, further comprising:
starting counting from the initial time point, and outputting a charging time abnormal signal to disable the pulse width modulation signal generator to produce the pulse width modulation signal when a counted accumulative time is greater than a predetermined charging time, and the feedback voltage does not reach a target voltage.

15. The control method of the flash charging protection circuit as claimed in claim 9, wherein the step of detecting whether the input voltage is abnormal, and outputting the power abnormal signal when the input voltage is abnormal comprises:
receiving a first predetermined voltage and a second predetermined voltage, and outputting the power abnormal signal when the detected input voltage of the power supply is not within a range of the first predetermined voltage and the second predetermined voltage.

16. The control method of the flash charging protection circuit as claimed in claim 9, further comprising:
detecting a system clock signal received by the flash charging protection circuit, and outputting a clock abnormal signal to disable the pulse width modulation signal generator to produce the pulse width modulation signal when a frequency of the system clock signal is lower than or greater than a predetermined working range.
